(19) United States
(12) Patent Application Publication
(10) Pub. No.: US 2010/0082153 A1
(43) Pub. Date: Apr. 1, 2010

(54) SUBSTRATE MANUFACTURING SYSTEM

(75) Inventor: Yuuzou SONOYAMA, Hikawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/554,120

(22) Filed: Sep. 4, 2009

(30) Foreign Application Priority Data
Sep. 30, 2008 (JP) 2008-254363

(51) Int. Cl. G06F 7/00; B65G 25/00

(52) U.S. Cl. 700/229; 414/157

(57) ABSTRACT

A substrate manufacturing system comprises a substrate processing device for conveying pallets from an inlet to an outlet; a pallet conveyor for sequentially returning the pallets for conveying the pallets from an outlet to an inlet; and a pallet controller including: a counter for counting the conveyed pallets at the inlet of the substrate processing device, a reference detector for detecting the reference pallet at the inlet of the substrate processing device, a first monitor for activating first alarm when the substrate lot is changed at the inlet of the substrate processing device and the reference detector detects absence of the reference pallet at the inlet of the substrate processing device, and a second monitor for activating second alarm when the counter counts the predetermined number of the pallets and the reference detector detects absence of the reference pallet at the inlet of the substrate processing device.

### CROSS-REFERENCE TO RELATED APPLICATIONS

This application is based upon and claims the benefit of priority of the prior Japanese Patent Application No. 2008-254363, filed on Sep. 30, 2008, the entire contents of which are incorporated herein by reference.

### FIELD

The embodiments discussed herein are relates to a substrates manufacturing system.

### BACKGROUND

The substrate manufacturing system to be disclosed in the specification generally includes a substrate processing device for processing plural substrates each mounted on the corresponding pallet while being sequentially conveyed from the inlet to the outlet, a pallet conveyor for sequentially returning the pallet having the substrate removed at the outlet to the inlet on another conveyor, and a pallet controller for controlling handling of those pallets.

The aforementioned substrate processing device as a preferred example of the aforementioned system is known as a reflow furnace for subjecting the electronic component on the surface mount (SMT) substrate to the solder pre-coating and the solder joint. The reflow furnace is provided with a pallet conveyor system (PCS) as the aforementioned pallet conveyor for automatically returning the empty pallet to the inlet again. It is further provided with a pallet controller for controlling handling of those pallets. The specification will explain mainly about the pallet controller, and the aforementioned reflow furnace and the PCS as a preferred example.

The art for controlling the end of processing the lot using the data substrate, and the art with respect to the FPC reflow conveyor pallet will be described as Japanese Unexamined Patent Application Publication No. 63-36410 and Japanese Unexamined Patent Application Publication No. 08-78838 described below.

FIG. 7 is a front view schematically illustrating the reflow furnace and the pallet conveyor as an example of the substrate manufacturing system.

In the drawing, a reference numeral 1 denotes the substrate manufacturing system which is mainly formed of a reflow furnace 2 as the substrate processing device and a pallet conveyor system (PCS) 3 as the pallet conveyor.

The reflow furnace 2 includes an inlet at the left side of the drawing. Substrates 4 are sequentially fed from the left side of the inlet while being mounted on corresponding pallets 5 sequentially fed on the PCS 3 such that palletized substrates 6 are input to the inlet.

Each of the palletized substrates 6 is subjected to the heat processing while being conveyed on the conveyor 7 in the reflow furnace 2 from the “inlet” toward the “outlet” thereof. Specifically, a large number of electronic components (not illustrated) on the respective substrates (PCB) 4 are subjected to the solder pre-coating and solder joint.

The heat processed palletized substrates 6′ are sequentially discharged from the outlet at the right side of the drawing so as to be separated into a processed substrate 4′ and an empty pallet 5. The processed substrates 4′ are sequentially fed rightward in the drawing to the subsequent step.

Meanwhile, the empty pallet 5 is returned from the “outlet” to the “inlet” of the reflow furnace 2 again on a conveyor 8 in the PCS 3 so as to be repeatedly used so long as the substrates 4 of the same lot are fed from the left side of the drawing. The empty pallet 5 discharged from the outlet is guided to the conveyor 8 by an outlet side lifter 9, and further conveyed to the inlet side (left side of the drawing). The empty pallet 5 returned to the inlet side is fed toward the inlet of the reflow furnace 2 again by a lifter 10 at the inlet side so as to allow the new substrate 4 of the same lot to be mounted thereon. It is fed into the furnace 2, and conveyed. The aforementioned processing is repeatedly performed until the end of supplying the substrates 4 of the same lot.

As it is clear from the aforementioned description, the pallet 5 is circulated in the system 1 so as to be repeatedly used. The PCS 3 is provided for the reflow furnace 2 for the circulation. The repetitive use of the pallet 5 is for the following reason.

The aforementioned surface mount (SMT) substrate 4 as small as about 0.8 mm tends to be so called “warped” in the high temperature reflow furnace 2. The “substrate warrpage” may adversely influence the performance of the electronic circuit board. The particular pallet suppresses the “substrate warrpage”. For example, the heat processing to the substrate 4 of type A requires the use of the pallet 5 for type A only.

FIG. 8 is a perspective view illustrating an example of the overview of the pallet 5. It is formed of a magnetic mesh material with the dimensions of X (370 mm) and Y (300 mm). Plural pins 11 stand on a mesh 12, each having the tip for horizontally supporting the substrate 4.

In the aforementioned case, layout of the respective pins 11 is strictly specified for each substrate. That is, the pins 11 are arranged so as not to abut against the respective electronic components on the back surface of the substrate 4. In the case where the aforementioned abutment occurs, the electronic component becomes defective, requiring the replacement with the normal component of the same type. If the electronic component to be replaced is such expensive component as BGA, the exchange cost may become high, and the man hour for the replacement will be increased, thus incurring negative cost in view of production.

The pin 11 is a magnetic pin which allows the layout to be changed by a pin layout jig MP flexibly for each type of the substrate. In this case, the change of the pallet 5 with the pin layout adapted to one type of the substrate during the production of the same lot is strictly inhibited.

Actually, however, there may be the case where the pallet noncompliant with the substrate is fed into the system 1 to cause the pin interference failure which leads to the negative cost incurrence. An example of the reason for the aforementioned failure will be described by the use of FIGS. 9, 10 and 11.

FIG. 9 is a plan view schematically illustrating the processing of the previous lot. FIG. 10 is a plan view schematically illustrating the state upon start of processing the subsequent new lot. The description below will be explained by taking the aforementioned advantage (i) as the example.

Referring to FIG. 9, the pallets 5A each having the pins 11A for type A on which the substrates 4A (not illustrated) are mounted are being conveyed on the conveyor 7 from the “inlet” to the “outlet” in the reflow furnace 2. An operator OPo (out) at the outlet side takes the processed substrate 4′A, and returns the pallet 5A to the inlet side of the reflow furnace 2 via the PCA 3. Thereafter, the arrangement for the next lot is changed.

Referring to FIG. 10, an operator OPi (in) at the inlet of the reflow furnace 2 mounts substrates 4B (not illustrated) of type B on the corresponding pallets 5B each with pins 11B for type B so as to be input onto the conveyor 7 sequentially. During the arrangement changing operation, if the operator forgets removal of the last pallet 5A, it will be returned to the inlet and the substrate 4B will be mounted on the pallet 5A, thus causing the pin interference failure.

FIG. 11 is an enlarged view of the structure extended from the one illustrated in FIG. 10, representing the flow (arrow) of the pallets disposed on the pallet conveyor (PCS) 3 at the inlet and outlet sides, and the conveyor 8 between the inlet and outlet sides. The reference numeral 5A denotes the pallet left unremoved during the arrangement changing operation.

As described above, since the inside of the reflow furnace 2 cannot be seen, the operator is not capable of confirming whether all the pallets 5A in the previous step have been removed in the previous step, or as to how may pallets have been input in the system 1, thus causing the pin interference failure.

It is thought that the aforementioned pin interference failure couldn't occur so long as the pallet control is strictly conducted. In the present circumstances where the multiobjective production is conducted to largely change each number of the respective lots (from 1000 to 100 pieces), the arrangement changing operation for switching the lot has to be performed several tens times a day, the pallet is commonly used for the parallel operation on the plural production lines, the pallet is removed and input again for coping with the trouble during the processing, frequent shift of the operator between the production lines and the like, it is very difficult to conduct the strict pallet control, thus incurring the negative cost resulting from the aforementioned pin interference failure.

### SUMMARY

According to an aspect of the invention, a substrate manufacturing system for manufacturing different type of substrates in substrate lots, the substrate manufacturing system comprises: a substrate processing device including predetermined number of pallets capable of mounting a substrate, the substrate processing device for conveying the pallets from an inlet to an outlet, the pallets including a reference pallet; a pallet conveyor for sequentially returning the pallets for conveying the pallets from an outlet to an inlet of the substrate processing device; and a pallet controller for controlling pallet management, the pallet controller including: a counter for counting the conveyed pallets at the inlet of the substrate processing device, a reference detector for detecting the reference pallet at the inlet of the substrate processing device, a first monitor for activating first alarm when the substrate lot is changed at the inlet of the substrate processing device and the reference detector detects absence of the reference pallet at the inlet of the substrate processing device, and a second monitor for activating second alarm when the counter counts the predetermined number of the pallets and the reference detector detects absence of the reference pallet at the inlet of the substrate processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a plan view schematically illustrating a substrate manufacturing system 1 according to an embodiment.

FIG. 2 illustrates a specific example of first and second operation panels (21, 22).

FIG. 3 illustrates a pallet control CPU 30 as a core component of a pallet controller 20 and its periphery.

FIG. 4 illustrates a specific function structure of the pallet control CPU 30.

FIG. 5 is a plan view illustrating an example of a reference mark M formed on a reference pallet 5R.

FIG. 6 is a flowchart illustrating an embodiment of a pallet control method disclosed in the specification.

FIG. 7 is a view schematically illustrating a reflow furnace and a packet conveyor as an example of the substrate manufacturing system.

FIG. 8 is a perspective view illustrating an exemplary overview of the pallet 5.

FIG. 9 is a plan view schematically illustrating processing of the previous lot.

FIG. 10 is a plan view schematically illustrating state upon start of processing the subsequent new lot.

FIG. 11 schematically illustrates the structure extended from the one illustrated in FIG. 10.

### DESCRIPTION OF EMBODIMENTS

Embodiments will be described below by referring figures.

Embodiments of a substrate manufacturing system are mainly formed of a reflow furnace 2 as the substrate processing device and a pallet conveyor system (PCS) 3 as the pallet conveyor.

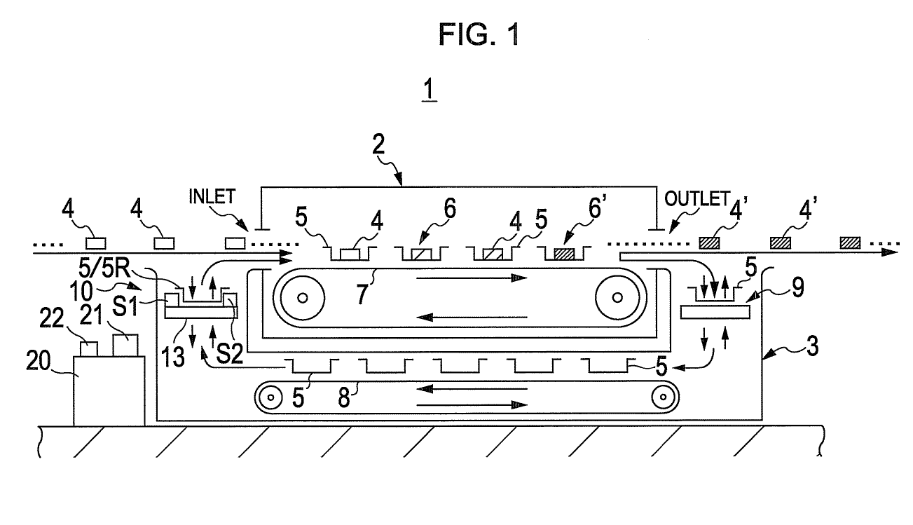

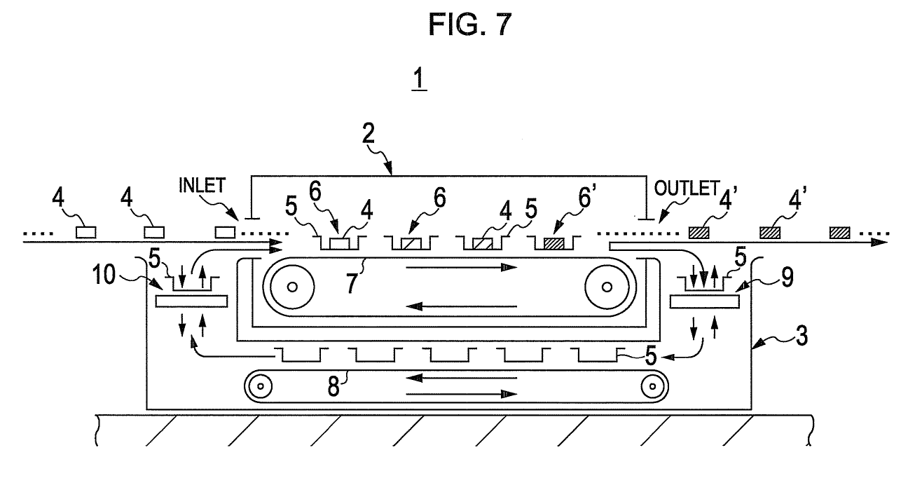

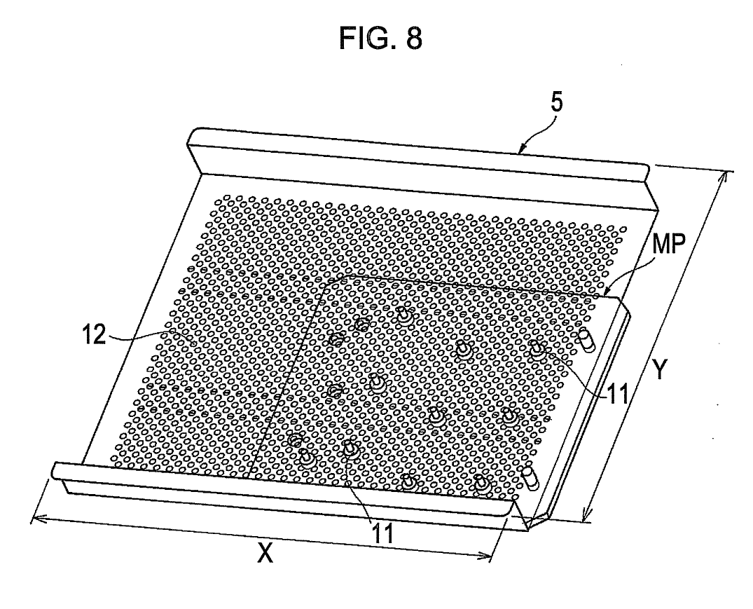

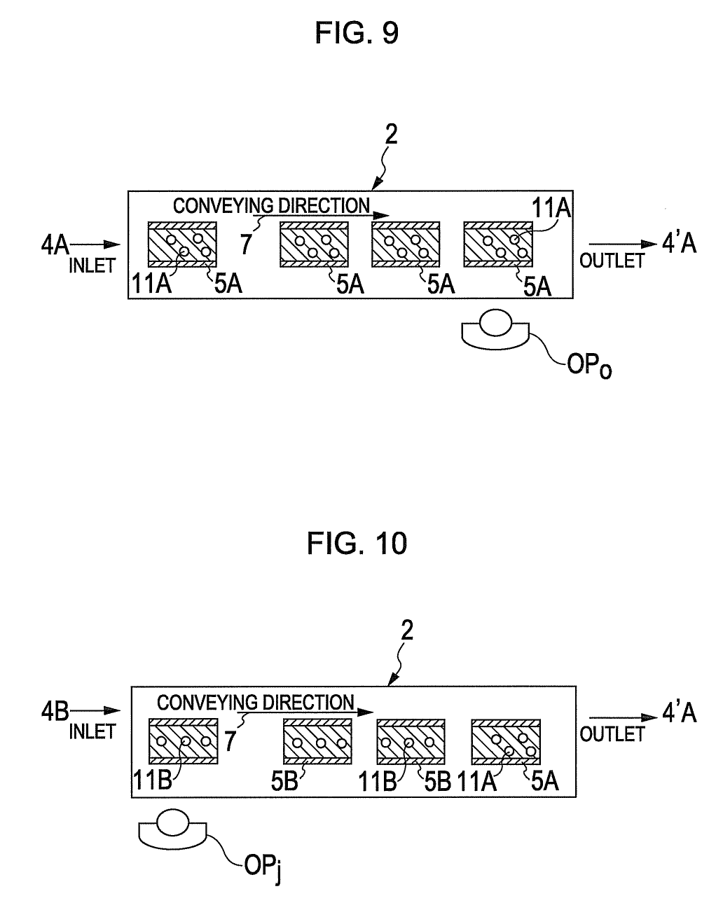

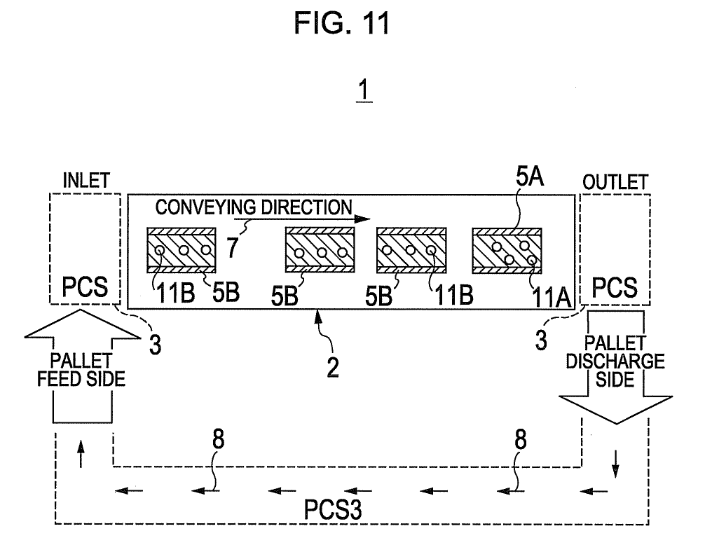

FIG. 1 is a front view schematically illustrating the substrate manufacturing system 1 according to an embodiment. The substrate manufacturing system 1 illustrated in the drawing is obtained by adding a pallet controller 20 to the system 1 as described referring to FIG. 7.

The pallet controller 20 is formed of a CPU (computer), and includes a first operation panel 21 and a second operation panel 22 each as a MMI (man-machine interface). The pallet controller 20 cooperates with a reference detection sensor S1 for outputting a first detection signal (D1) and a pallet detection sensor S2 for outputting a second detection signal (D2).

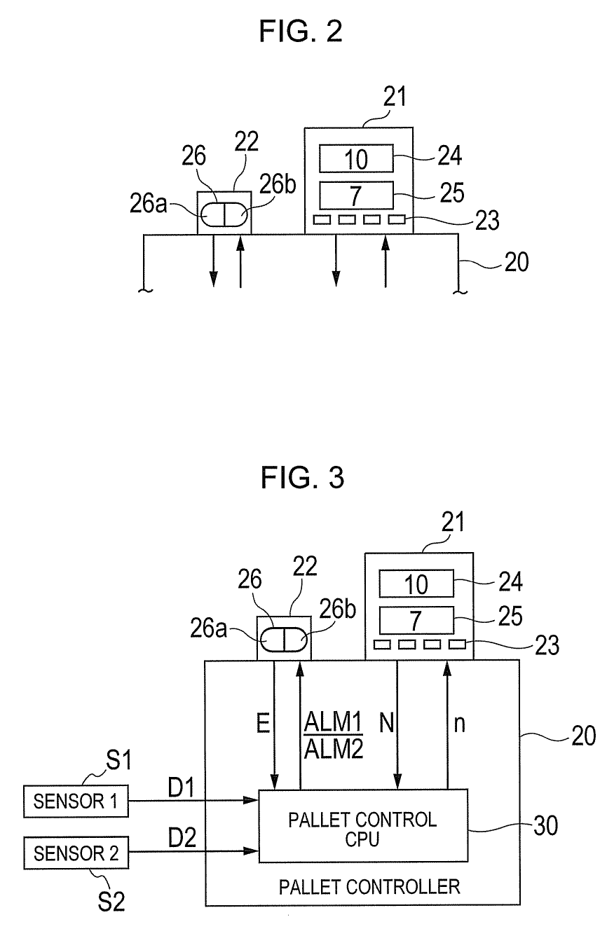

FIG. 2 illustrates a specific example of the first and the second operation panels (21, 22) in detail. The first operation panel 21 includes a set button 23 for setting the predetermined number of the pallets, a first display 24 for displaying the set predetermined number (for example, “10”), and a second display 25 for displaying the count value to be decremented as the pallets are sequentially conveyed.

Meanwhile, the second operation panel 22 includes a start button 26 to be depressed upon start of inputting the substrates 4 of the log group into the inlet. In consideration with the convenience for the operator OPi, the start button 26 has built-in first lamp 26a and second lamp 26b which illuminate first and second alarms ALM1 and ALM2 (to be described later) upon abnormality, respectively. In consideration with the convenience for the operator OPi, the start button 26 has built-in first lamp 26a and second lamp 26b which illuminate or flash on and off first alarm ALM1 and second alarm and ALM2 upon abnormality, respectively.

FIG. 3 illustrates a pallet control CPU 30 as a core component of the pallet controller 20, and its periphery. The pallet control CPU 30 receives an input of the predetermined number N of the pallets 5 from the first operation panel 21, and sends back the input number n to the present (or the number of left pallets) to the first operation panel 21. Upon reception of a command E for starting the input of the pallet from the second operation panel 22, or activation of the alarm ALM1 or ALM2, the command or the alarm will be output to the second operation panel 22. In this case, upon reception of the input of the signal D1 from the reference detection sensor S1 and the signal D2 from the pallet detection sensor S2, the input number of the pallets is counted, and the alarm is activated. The aforementioned functions of the pallet control CPU 30 will be described hereinafter.

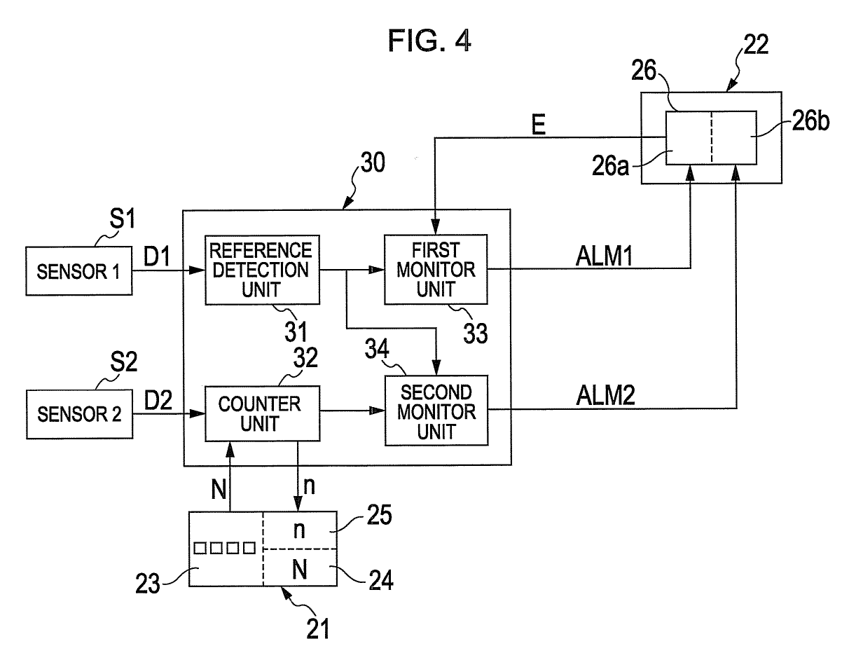

FIG. 4 illustrates a detailed function structure of the pallet control CPU 30 which is mainly formed of a reference detector 31, a counter 32, a first monitor 33, and a second monitor unit 34.

The counter 32 counts the value at the “inlet” of the reflow furnace 2 by decrementing the predetermined number of the pallets 5 input into the substrate processing device (reflow furnace) 2 for processing the substrate 4 to be conveyed on the conveyor (7) accompanied with the flow of feeding the pallets 5. Meanwhile, the reference detector 31 sets one of the predetermined numbers of the pallets 5 as the reference pallet 5R, and monitors the flow of the reference pallet 5R at the inlet of the reflow furnace 2.

The first monitor 33 activates the first alarm ALM1 when the substrates 4 of the lot group to be processed are input at the inlet, and the reference detector 31 detects that the first pallet of the lot group does not coincide with the reference pallet 5R.

Meanwhile, the second monitor unit 34 activates the second alarm ALM2 when an absence of the reference pallet 5R is detected by the reference detector 31 at the timing when the counter 32 finishes counting the predetermined number of the pallets 5 returning from the circulation.

The first monitor 33 cooperates with the reference detection sensor S1 which outputs the first detection signal D1 indicating incoming of the reference pallet 5R to the reference detector 31. Meanwhile, the second monitor unit 34 cooperates with the pallet detection sensor S2 which outputs the second detection signal indicating passages of the reference pallet 5R and the rest of the pallets 5 to the counter 32. Upon reception of a set signal N output from the first operation panel 21 for setting the predetermined number, the counter 32 decrements the set value by 1 (n) for each reception of the second detection signal D2.

Meanwhile, the second operation panel 22 outputs an activation signal E in response to depression of the start button 26. Upon reception of the activation signal E output from the second operation panel 22 for starting the input of the substrates 4 of the lot group into the “inlet” of the reflow furnace 2, the first monitor 33 starts monitoring the incoming of the reference pallet 5R.

The reference detection sensor S1 is provided for the aforementioned monitoring operations. It is preferable to dispose the reference detection sensor S1 at the inlet side of the reflow furnace 2. In an embodiment, it is provided on a part of a lift base 13 of a lifter 10 at the input side. The pallet detection sensor S2 is also provided on the other part of the lift base 13.

Photo sensors may be used for these sensors S1 and S2. The pallet detection sensor S2 detects the light reflected on the back side of the pallet 5. Meanwhile, the reference detection sensor S1 optically detects a reference mark (M) which has been preliminarily formed on a part of the reference pallet 5R. In an example, a through hole is simply formed as the reference mark (M), which is illustrated in the drawing.

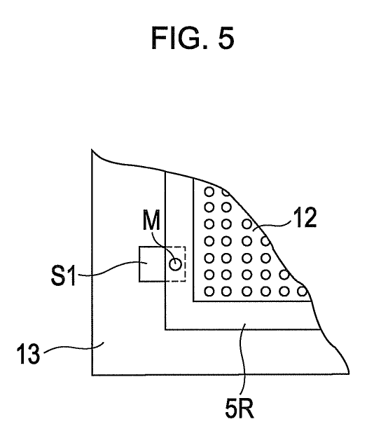

FIG. 5 is a plan view illustrating an example of the reference mark M formed in the reference pallet 5R. Referring to the drawing, the reference detection sensor (photo sensor) S1 is fixed to the part of the lift base 13 as described above. The reference pallet 5R conveyed on the conveyor 8 from the outlet side is mounted on the lift base 13 at the inlet side. The sensor S1 determines that the pallet with the reference mark M is the reference pallet 5R. The reference mark M is formed as the through hole. The sensor S1 does not receive the reflecting light from the reference pallet. That is, no reception of the light indicates the detection of the reference pallet (DI).

The use of the through hole (M) allows the same sensor to be employed for the sensors S1 and S2. The reference pallet 5R may be easily provided only by partially forming the hole in any one of the pallets 5.

The substrate manufacturing system 1 disclosed in the specification (FIG. 1) has the following structure.

The substrate manufacturing system 1 includes a substrate processing device (reflow furnace) 2 which processes plural substrates 4 mounted on the pallets 5 and 5R while being sequentially conveyed on the conveyor (7) from the “inlet” to the “outlet”, a pallet conveyor (PCS) 3 which returns the pallets 5, 5R each having the substrate 4 removed at the outlet to the inlet while being conveyed on another conveyor (8), and a pallet controller 20 which controls handling of the pallets 5.

The pallet controller 20 includes the pallet control CPU 30 which contains the counter 32 for counting the value at the inlet by decrementing the predetermined number of the pallets 5 input into the substrate processing apparatus (reflow furnace) 2 accompanied with the flow of the pallets, and the reference detector 31 for monitoring the flow of the preliminarily set reference pallet 5R as one of the predetermined number of pallets at the inlet.

The pallet control CPU 30 further includes the first monitor 33 for activating the first alarm ALM1 when the reference detector 31 detects that the first pallet upon start of inputting the substrates 4 of the lot group sequentially mounted on the pallets 5 and 5R into the inlet does not coincide with the reference pallet 5R, and the second monitor unit for activating the second alarm ALM2 when the reference pallet 5R is not detected by the reference detector 31 at the timing when the counter 32 finishes counting the predetermined number after the predetermined number of the pallets 5 and 5R on the conveyors (7, 8) return from circulation.

The pallet control CPU 30 contains the pallet control program for the substrate manufacturing system 1. The program allows the computer to execute the step for discharging the pallets of the previous lot which have been already input in the substrate processing device (reflow furnace) upon start of inputting the substrates of the lot group sequentially into the inlet, the step for allowing the value corresponding to the predetermined number of pallets to be set on the counter 32 upon start of inputting the substrates of the lot group into the inlet sequentially, the step for starting the input of the substrates of the lot group sequentially, the step for activating the alarm to stop conveyance when it is determined that the first pallet upon start of inputting does not coincide with the reference pallet, and continuing the conveyance when it is determined that the first pallet coincides with the reference pallet, the step for decrementing the counter value by the number of the pallets as they are input into the inlet during the conveyance, and the step for activating the alarm to stop the conveyance when it is determined that the reference pallet has not been returned at the timing when the decrement of the value performed by the counter unit is finished, and continuing the conveyance when it is determined that the reference pallet has been returned.

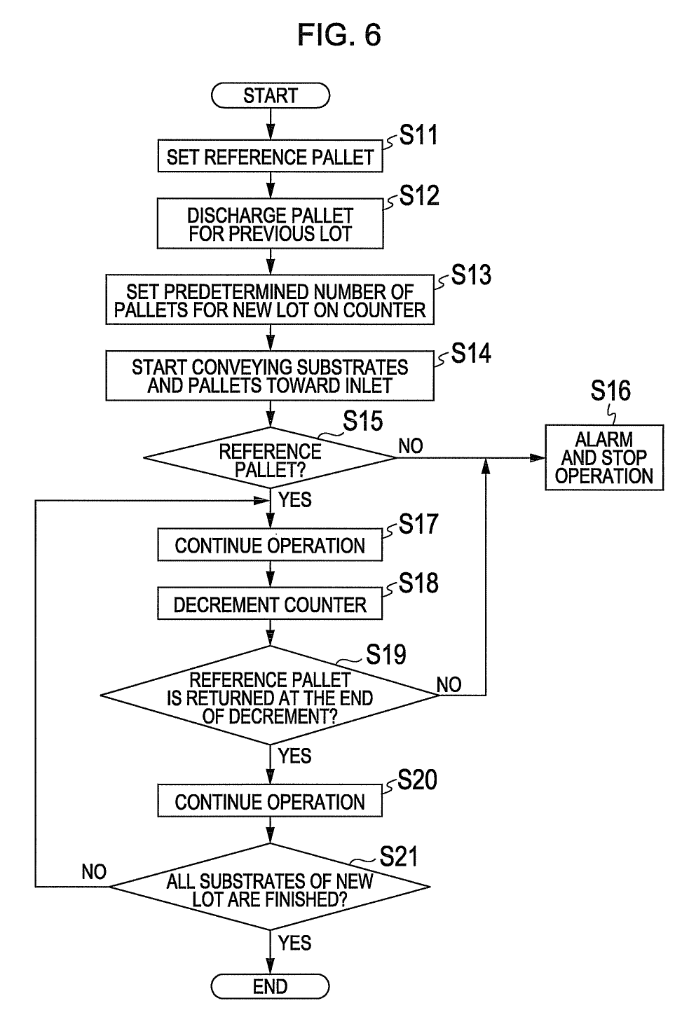

FIG. 6 is a flowchart illustrating an embodiment of the pallet control method as disclosed in the specification.

Step S11: The reference mark M is formed on any one of the predetermined number of pallets 5 which are left stand-by toward the inlet of the reflow furnace 2 for conveying the substrates 4 of the lot group on the conveyor (7). The pallet with the reference mark M is set as the reference pallet 5R.

Step S12: The pallets of the previous lot which have been input in the reflow furnace 2 are discharged upon start of inputting the substrates 4 of the new lot group into the inlet sequentially. (note: However, the system does not check whether or not all the pallets have been discharged from the outside of the furnace 2.)

Step S13: The value corresponding to the predetermined number of the pallets 5 is set on the counter 32 upon start of inputting the substrates 4 of the new lot group into the inlet of the reflow furnace 2 sequentially.

Step S14: The sequential input of the pallets 5 into the inlet together with the substrates 4 of the new lot group is started.

Step S15: It is determined whether or not the first pallet upon the start of inputting coincides with the reference pallet 5R. If the first pallet does not coincide with the reference pallet 5R, the first alarm ALM1 is activated to stop conveyance on the conveyor (7) (step S16). If the first pallet coincides with the reference pallet 5R, the conveyance on the conveyor (7) is continuously performed (step S17).

Step S18: During the continuous conveyance, for every input of the pallet 5 into the inlet of the reflow furnace 2, the value of the counter 32 is decremented by the number of the input pallet.

Step S19: It is determined whether or not the reference pallet 5R has been returned to the inlet at the timing when the counter 32 finishes decrementing the value. If it has not been returned, the second alarm ALM2 is activated to stop the conveyance (step S16). If it has been returned, the conveyance is continued (step S20).

Step S21: The routine is repeatedly executed until all the substrates of the lot are processed.

In step S19, if the reference pallet 5R has not been returned at the timing when the counter 32 finishes decrementing the value, it is determined that the pallet 5 for the previous lot is left in the reflow furnace 2 or another pallet 5 is input from the outlet or the inlet of the reflow furnace 2 during the conveyance on the conveyor (7, 8). Then the alarm is activated to stop the conveyance.

If the reference pallet 5R has been already returned at the timing when the counter 32 finishes decrementing the value, it is determined that any pallet has been removed from the outlet or the inlet of the reflow furnace 2 during the conveyance on the conveyor (7, 8). Then the alarm is activated to stop the conveyance.

The step for automatically setting the value to the counter 32 performed when the reference pallet 5R is just returned at the time point when the counter 32 finishes decrementing the value may be added.

The step for detecting the number of the currently conveyed pallets on the conveyor (7) in the reflow furnace 2 from the current value of the counter 32 so as to be displayed on the second display 25 (FIG. 2) may be added.

The pin interference failure caused by omission of removing the pallet for the previous lot from the reflow furnace may be prevented with simple and less expensive means. The specific description of the structure will be described as below.

[Advantages]

The aforementioned substrate manufacturing system provides the following advantages.
(i) It is assumed that processing of the substrates 4A of type A mounted on the corresponding pallets 5A for the type A have been finished, and the processing of the substrates 4B of type B mounted on corresponding pallets 5B for the type B is started after changing the arrangement. The pallet 5A in the previous step left in the system 1 may be detected by the second check (excessive count of the counter) so as to prevent the pin interference failure.
(ii) Inconsistency in the predetermined number of the pallets 5B for the type B may be detected to ensure correct handling of the predetermined number of the pallets on a constant basis.
(iii) The user is allowed to easily confirm as to how many pallets circulating to be fed into the reflow furnace (or discharged from the reflow furnace) precede the reference pallet as the reference point. The inside of the reflow furnace 2 may not be seen from outside. The information with respect to the location of the circulating pallet illustrates the current operation status immediately in the case of shift of the operator from the current production line to the other.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A substrate manufacturing system for manufacturing different type of substrates in substrate lots, the substrate manufacturing system comprising:
a substrate processing device including predetermined number of pallets capable of mounting a substrate, the substrate processing device for conveying the pallets from an inlet to an outlet, the pallets including a reference pallet;
a pallet conveyor for sequentially returning the pallets for conveying the pallets from an outlet to an inlet of the substrate processing device; and
a pallet controller for controlling pallet management, the pallet controller including:
a counter for counting the conveyed pallets at the inlet of the substrate processing device,
a reference detector for detecting the reference pallet at the inlet of the substrate processing device,
a first monitor for activating first alarm when the substrate lot is changed at the inlet of the substrate processing device and the reference detector detects absence of the reference pallet at the inlet of the substrate processing device, and
a second monitor for activating second alarm when the counter counts the predetermined number of the pallets and the reference detector detects absence of the reference pallet at the inlet of the substrate processing device.

2. The substrate manufacturing system of claim 1, further comprising a reference detection sensor for detecting the reference pallet and for outputting a first detection signal to the reference detector when the reference pallet is detected by the sensor.

3. The substrate manufacturing system of claim 2;
wherein the pallet includes a reference mark,
wherein the reference detection sensor detects the reference mark on the pallet.

4. The substrate manufacturing system of claim 2, further comprising a pallet detection sensor for outputting a second detection signal indicating passages of the pallets to the counter.

5. The substrate manufacturing system of claim 4, further comprising an operation panel for operating the counter;
wherein the counter is set the predetermined number of the pallet by the operation panel.

6. The substrate manufacturing system of claim 1, further comprising an operation panel for operating the first monitor;
wherein the first monitor starts monitoring of the reference pallet at the inlet of the substrate processing device when the first monitor receives a start signal from the operation panel.

7. The substrate manufacturing system of claim 1, further comprising an operation panel including a button having a built in lamp;
wherein the first monitor and the second monitor activate alarm by the use of the built in lamp in the operation panel.

8. The substrate manufacturing system of claim 1, wherein the substrate processing device is a reflow furnace and the substrate is a surface mount substrate.

9. A pallet management method for a substrate manufacturing system to manufacture different type of substrates by the use of the different type of pallets in substrate lots, the substrate manufacturing system including a substrate processing device including predetermined number of pallets capable of mounting a substrate, the substrate processing device for conveying the pallets from an inlet to an outlet, a pallet conveyor for sequentially returning the pallets for conveying the pallets from an outlet to an inlet of the substrate processing device, and a pallet controller for controlling pallet management, the pallet management method, comprising:
preparing a reference pallet including a reference mark in the pallets;
counting the conveyed pallets at the inlet of the substrate processing device;
detecting the reference pallet at the inlet of the substrate processing device;
activating first alarm when the substrate lot is changed at the inlet of the substrate processing device and absence of the reference pallet is detected at the inlet of the substrate processing device; and
activating second alarm when the predetermined number of the pallets is counted and absence of the reference pallet is detected at the inlet of the substrate processing device.

10. The pallet management method of claim 9, further comprising stopping the pallet conveyor when the alarm is activated.

11. The pallet management method of claim 9, further comprising stopping the pallet conveyor when the predetermined number of the pallet is counted and absence of the reference pallet is detected at the inlet of the substrate processing device.

12. The pallet management method of claim 9, further comprising determining to leave a previous lot of the substrate when the predetermined number of the pallets is counted and absence of the reference pallet is detected at the inlet of the substrate processing device.

13. The pallet management method of claim 9, further comprising determining another lot of the substrate inputted at the inlet of the substrate processing device when the predetermined number of the pallets is counted and absence of the reference pallet is detected at the inlet of the substrate processing device.

14. The pallet management method of claim 9, further comprising determining any pallet being removed from the outlet or the inlet of the substrate processing device when the predetermined number of the pallets is counted and the reference pallet is already detected at the inlet of the substrate processing device.

15. The pallet management method of claim 9, further comprising setting the predetermined number of the pallets when the predetermined number of the pallets is counted and the reference pallet is just detected at the inlet of the substrate processing device.
